(19) United States
(12) Patent Application Publication
(10) Pub. No.: US 2008/0000973 A1
(43) Pub. Date: Jan. 3, 2008

(54) Casing structure for card reader

(76) Inventors: Wei-Jung Lin, Taipei (TW); Chih-Hsu Tsai, Taipei (TW); Chih-Ching Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/478,723

(22) Filed: Jul. 3, 2006

(51) Int. Cl. G06K 7/00

(52) U.S. Cl. 235/439

(57) ABSTRACT

A casing structure for a card reader is disclosed. The casing structure is composed of at least an upper casing structure and a lower casing structure. In addition, an elastic hook and a hook notch are disposed on at least a side of the upper casing structure. A protruding cylinder and a support cylinder are disposed on a side of the lower casing structure. After the hook notch covering the support cylinder, the elastic hook can be displaced flexibly for hooking the protruding cylinder. Hence the upper casing structure then covers the lower casing structure tightly.

### FIELD OF THE INVENTION

The present invention relates to a casing structure for a card reader, and more particularly to the design of the hook structure for an upper casing and a lower casing of the casing structure.

### BACKGROUND OF THE INVENTION

A development for combining an automatic vending machine with a card satisfies the demands of people on shopping.

Referring to FIG. 1, a schematic diagram illustrates a conventional automatic vending machine combined with a card in prior arts. As shown in FIG. 1, a card reader 11 is disposed on the automatic vending machine 10. The card reader 11 has a card identification unit 111 for identifying a card 12. The identification way is that a predetermined mark on a surface of the card 12 is read by a sensor 112 first. A processor 113 then analyzes the predetermined mark. However, when functions of the card reader tend to complexity and precision, designers or maintainers for the card reader 11 must open the card reader 11 periodically to maintain or to renew software, firmware or hardware components. General speaking, a clean work may be seen as the maintaining work. The card reader 11 is locked by some screws (not shown). The maintainers must use tools to release the screws one by one in order to dismount the card reader 11 or merely dismount an upper casing 114 of the card reader 11. After the dismounting is done, the screws are then screwed one by one. Therefore, the invention provides a new casing structure for a card reader to reduce workloads for the designers and the maintainers.

In addition, the card reader is not only used in the automatic vending machine or the game console; but is also in widespread use in many stores. However, the maintaining work or the updating work is also complex as the aforesaid example of the automatic vending machine. The invention also provides a new casing structure for a card reader to simplify complexity on maintaining or updating

### SUMMARY OF THE INVENTION

Accordingly, the primary object of the present invention is to provide a casing structure for a card reader to simplify the complex procedure on maintaining and renewing a conventional card reader.

The second object of the present invention is to provide a casing structure for card readers for use in an automatic vending machine, a game console or relative machines to reduce workloads of designers and maintainers.

To achieve the forgoing objects, the casing structure for the card reader provided by the present invention includes an upper casing structure and a lower casing structure. In addition, at least one side of the upper casing structure of the casing structure has an elastic hook and a hook notch. Corresponding to the elastic hook and the hook notch, a side of the lower casing structure also has a protruding cylinder and a support cylinder. It should be noted that a coin machine or other reader is used to replace the card reader. In another word, the casing structure for the card reader is taken into a preferred embodiment to clearly illustrate the spirit of the present invention. Hence, the casing structure disclosed by the present invention is not limited to the card reader, but also includes any reading apparatus.

When the upper casing structure covers the lower casing structure, the hook notch of the upper casing structure and the support cylinder are buckled in advance. The elastic hook of the upper casing structure then produces displacement through the flexibility of the elastic hook. The upper casing structure then covers the lower casing structure in advance. Lastly, when an active force with the opposite direction is generated due to displacement, the elastic hook then returns to an original position. Hence, the elastic hook could hook the protruding cylinder of the lower casing structure. The upper casing structure then covers the lower casing structure tightly.

Other features and advantages of the present invention and variations thereof will become apparent from the following description, drawings, and claims.

### BRIEF DESCRIPTION OF THE DRAWINGS

FIG. 1 is a schematic diagram illustrating an automatic vending machine combined with a card in prior arts;

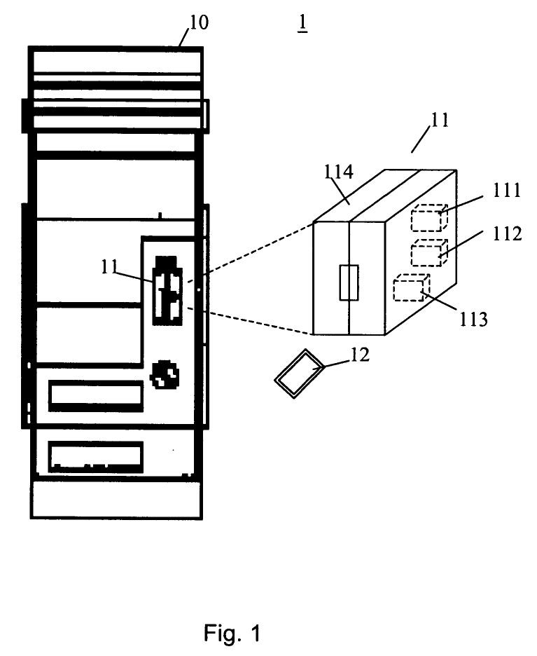

FIG. 2 is a schematic diagram illustrating a casing structure for a card reader according to an embodiment of the present invention;

FIG. 3 is a schematic diagram (I) illustrating an upper casing structure and a lower casing structure of a casing structure according to an embodiment of the present invention;

FIG. 4 is a schematic diagram (II) illustrating an upper casing structure and a lower casing structure of a casing structure according to an embodiment of the present invention;

FIG. 5 is a schematic diagram illustrating an upper casing covered the lower casing structure according to an embodiment of the present invention;

FIG. 6 is a perspective drawing illustrating a casing structure for a card reader according to an embodiment of the present invention; and

FIG. 7 is a side elevation according to FIG. 6; and

FIG. 8 is a top view according to FIG. 6.

### DETAILED DESCRIPTION OF THE PREFERRED EMBODIMENTS

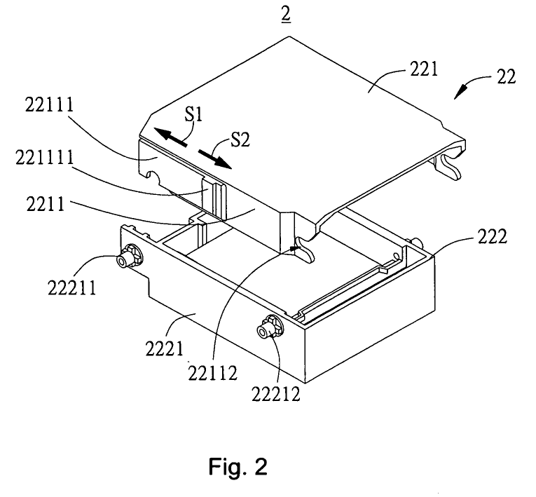

Referring to FIG. 2, a schematic diagram illustrates a casing structure for a card reader according to an embodiment of the present invention. As shown in FIG. 2, the casing structure 22 for the card reader includes an upper casing structure 221 and a lower casing structure 222. The card reader can be secured in the upper casing structure 221 or the lower casing structure 222 in advance. In addition, at least one side 2211 of the upper casing structure 221 has an elastic hook 22111 and a hook notch 22112. A protruding ridge 221111 is disposed on the elastic hook 22111. A force is then provided to push the protruding ridge 221111. The elastic hook 22111 then performs displacements S1 and S2 on the side 2211. Moreover, for corresponding to the side 2211 of the upper casing structure 221, a side 2221 of the lower casing structure 222 also has a protruding cylinder 22211 and a support cylinder 22212. It should be noted that other data readers like a coin machine or relative reading apparatuses are used to replace the card reader.

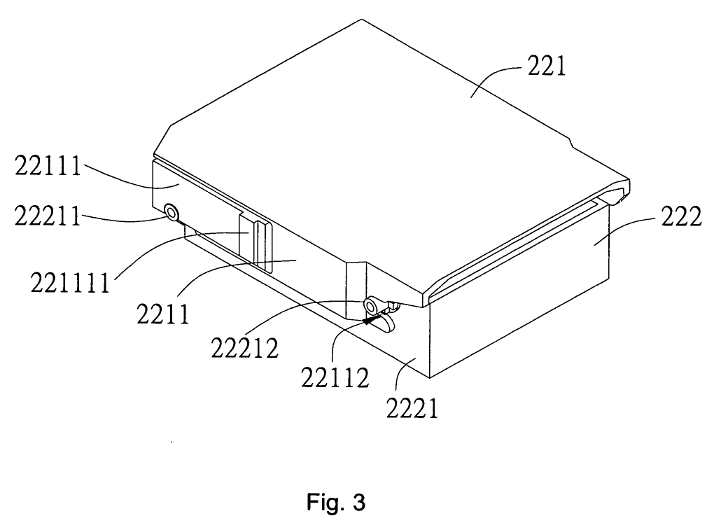

Referring to FIG. 3, a schematic diagram (I) illustrates the upper casing structure 221 closing the lower casing structure 222. As shown in FIG. 3, the hook notch 22112 of the upper casing structure 221 is buckled to the support cylinder 22212 of the lower casing structure 222.

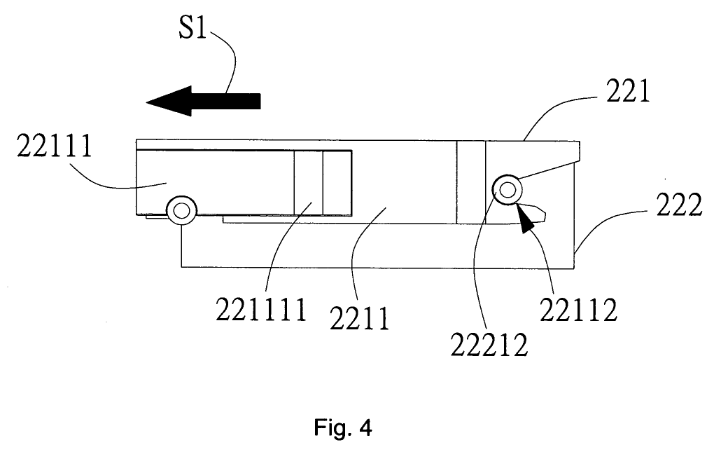

Referring to FIG. 4, a schematic diagram (II) illustrates the upper casing structure 221 closing the lower casing structure 222. As shown in FIG. 4, the hook notch 22112 of the upper casing structure 221 has buckled to the support cylinder 22212 of the lower casing structure 222. The upper casing structure 221 has covered the lower casing structure 222. Under the covering condition an external force is imposed on the protruding ridge 221111 of the elastic hook 22111 of the upper casing structure 221. The elastic hook 22111 then performs the displacement motion S1 on the side 2211.

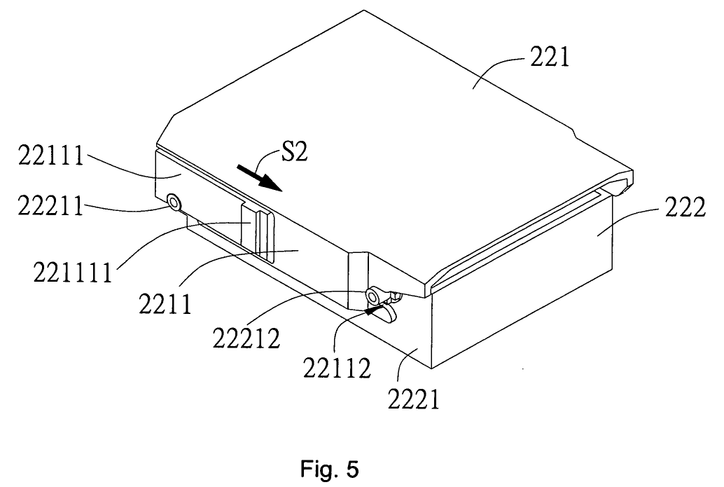

Referring to FIG. 5, a schematic diagram illustrates the upper casing structure 221 covering the lower casing structure 222 completely. As shown in FIG. 5, the hook notch 22112 of the upper casing structure 221 has buckled to the support cylinder 22212 of the lower casing structure 222. The upper casing structure 221 has covered the lower casing structure 222. Because the force pushed on the protruding ridge 221111 has been released, the elastic hook 22111 then performs the displacement S2 through a reactive force generated from a spring of the elastic hook 22111. The elastic hook 22111 is hooked the protruding cylinder 22211.

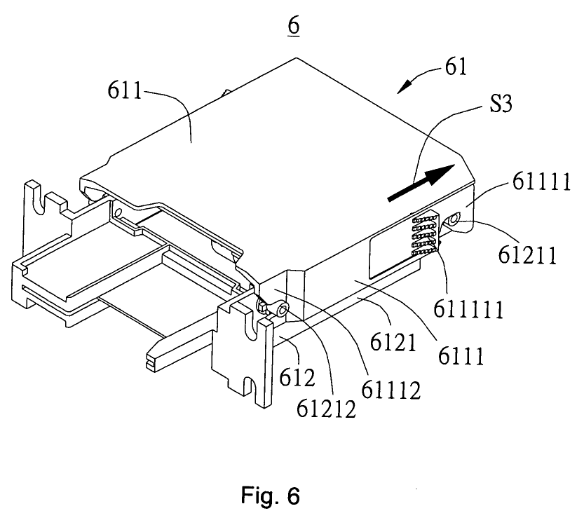

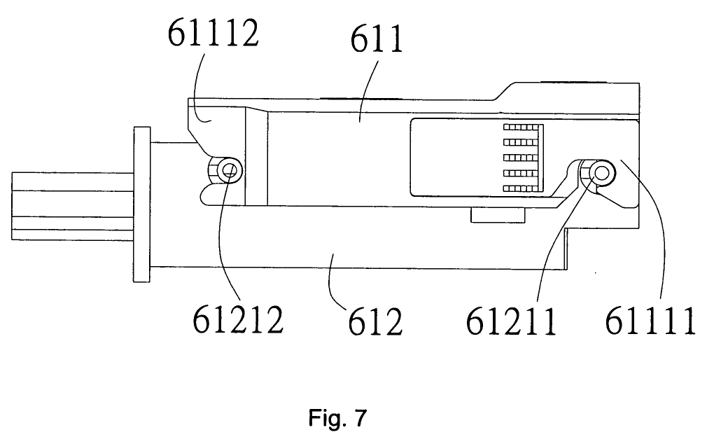

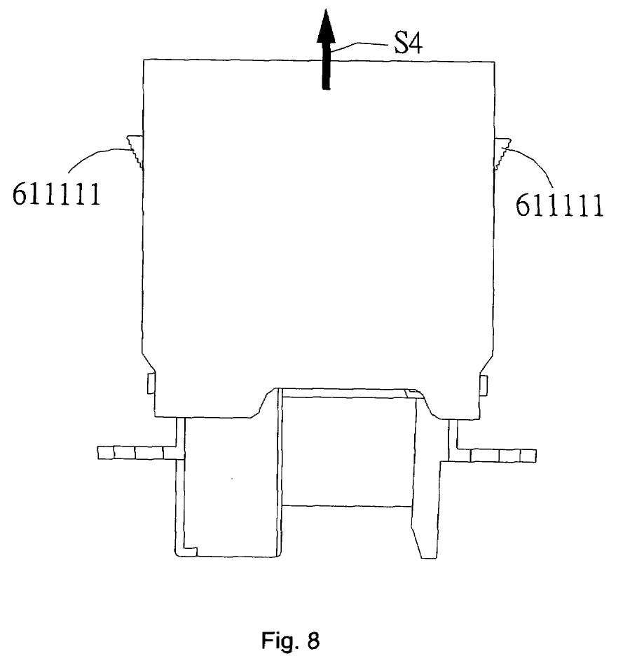

Referring to FIG. 6, FIG. 7 and FIG. 8, diagrams illustrate a casing structure for a card reader according to preferred embodiments of the present invention.

Referring to FIG. 6, a perspective drawing illustrates a casing structure for a card reader according to an embodiment of the present invention. As shown in FIG. 6, the card reader 6 includes a shell 61. The shell 61 includes an upper casing 611 and a lower casing 612. In addition, two sides 6111 of the upper casing 611 have a hook 61111 and a notch 61112. A protruding ridge 611111 is disposed on the hook 61111. An external force is then provided to push the protruding ridge 611111. The hook 61111 then performs the outward displacement S3 on the two sides 6111. Moreover, two sides 6121 of the lower casing 612 which corresponds to the two sides 6111 of the upper casing 611 also have a protruding cylinder 61211 and an axial cylinder 61212.

Referring to FIG. 7, a side elevation is according to FIG. 6. As shown FIG. 7, the hook 61111 of the upper casing 611 is buckled the protruding cylinder 61211 of the lower casing 612. The notch 61112 of the upper casing 611 is buckled the axial cylinders 61212 of the lower casing 612. The upper casing 611 then covers the lower casing 612 tightly.

Referring to FIG. 8, a top view is according to FIG. 6. As shown in FIG. 8, a user uses his thumb and first finger of one hand to push the protruding ridges 611111 of the two sides of the upper casing 611, thereby imposing an external force toward the displacement direction S4. Therefore, the upper casing 611 is easily removed from the lower casing 612.

In addition, the casing structure for the card reader disclosed by the present invention can be further applied to card readers for an automatic vending machine, a game console or relative machines. Moreover, the card reader can be replaced by other data reading apparatuses like a coin machine or other readers.

Although the features and advantages of the embodiments according to the preferred invention are disclosed, it is not limited to the embodiments described above, but encompasses any and all modifications and changes within the spirit and scope of the following claims.

What is claimed is:

1. A casing structure for a card reader, comprising:
an upper casing structure having a side, said side having an elastic hook; and
a lower casing structure having a side, said side corresponded to said side of said upper casing and having a protruding cylinder.

2. The casing structure of claim 1, wherein said side of said upper casing structure further has a hook notch.

3. The casing structure of claim 2, wherein said side of said lower casing structure further has a support cylinder.

4. The casing structure of claim 3, wherein said hook notch and said support cylinder are buckled in advance to provide said elastic hook for hooking said protruding cylinder.

5. A casing structure for a card reader, comprising:
an upper casing structure having a side, said side having an elastic hook and a hook notch; and
a lower casing structure having a side, said side corresponded to said side of said upper casing structure, said side having a protruding cylinder and a support cylinder.

6. The casing structure of claim 5, wherein said hook notch and said support cylinder are buckled in advance to provide said elastic hook for hooking said protruding cylinder.

7. A casing structure for a card reader for use in card readers of an automatic vending apparatus, a game console or a relative machine, comprising:
an upper casing structure having a side, said side having an elastic hook; and
a lower casing structure having a side, said side corresponded to said side of said upper casing structure, said side having a protruding cylinder.

8. The casing structure of claim 7, wherein said side of said upper casing structure further has a hook notch.

9. The casing structure of claim 8, wherein said side of said lower casing structure further has a support cylinder.

10. The casing structure of claim 9, wherein said hook notch and said support cylinder are buckled in advance to provide said elastic hook for hooking said protruding cylinder.

11. A casing structure for a card reader for use in card readers for an automatic vending apparatus, a game console or a relative machine, comprising:
an upper casing structure having a side, said side having an elastic hook and a hook notch; and
a lower casing structure having a side, said side corresponded to said side of said upper casing structure, said side having a protruding cylinder and a support cylinder.

12. The casing structure of claim 11, wherein said hook notch and said support cylinder are buckled in advance to provide said elastic hook for hooking said protruding cylinder.

13. A casing structure, comprising:
an upper casing structure having a side, said side having an elastic hook; and
a lower casing structure having a side, said side corresponded to said side of said upper casing structure, said side having a protruding cylinder.

14. The casing structure of claim 13, wherein said side of said upper casing structure further has a hook notch.

15. The casing structure of claim 14, wherein said side of said lower casing structure further includes a support cylinder.

16. The casing structure of claim 15, wherein said hook notch and said support are buckled in advance to provide said elastic hook for hooking said protruding cylinder.

17. A casing structure, comprising:
an upper casing structure having a side, said side having an elastic hook and a hook notch; and
a lower casing structure having a side, said side corresponded to said side of said upper casing structure, said side having a protruding cylinder and a support cylinder.

18. The casing structure of claim 17, wherein said hook notch and said support cylinder are buckled in advance to provide said elastic hook for hooking said protruding cylinder.
